(19) United States
(12) Patent Application Publication
(10) Pub. No.: US 2012/0275836 A1
(43) Pub. Date: Nov. 1, 2012

(54) IMAGE FORMING APPARATUS AND METHOD THEREOF

(76) Inventors: Giries Kadis, Jaffa (IL); Wael Salalha, Bet Jan galil (IL); Shunit Petachia, Netanya (IL); Sharon Nagler, Gan Yavna (IL); Marko Richter, Rehovot (IL); Assaf Bendek, Ashdod (IL); Roy Har-Tsvi, Kiryat Motzkin (IL)

(21) Appl. No.: 13/096,610

(22) Filed: Apr. 28, 2011

(51) Int. Cl. G03G 21/00

(52) U.S. Cl. 399/343

(57) ABSTRACT

A method of maintaining a photoconductive member of an image forming apparatus is disclosed. The method includes applying fluid to a photoconductive member to form an image thereon, transferring the fluid from the photoconductive member in the form of the image and providing sponge applicator fluid to respective sponge applicator units. The method also includes squeezing the sponge applicator units to remove at least a portion of the sponge applicator fluid therefrom and sequentially placing each one of the sponge applicator units in contact with the photoconductive member to cool and clean the photoconductive member.

### BACKGROUND

Image forming apparatuses such as liquid electrophotography systems include a fluid applicator unit such as binary ink developers to provide charged liquid toner to a latent image on a photoconductive member to form fluid images. The photoconductive member transfers the fluid images therefrom onto a heated intermediate transfer member. Subsequently, the intermediate transfer member transfers the fluid images to media.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 is a schematic view illustrating a liquid electrophotography system according to an example.

FIG. 2 is a block diagram illustrating an image forming apparatus according to an example.

FIG. 3 is a cross-sectional view illustrating a portion of the image forming apparatus of FIG. 2 according to an example.

FIG. 4 is an elevational view illustrating sponge rollers and a wiping member of the image forming apparatus of FIG. 3 according to an example.

FIGS. 5A-5C are schematic diagrams illustrating sequential engagement states of the respective sponge rollers of the image forming apparatus of FIG. 3 according to an example.

FIG. 5D is a side view of a maintenance assembly frame of the image forming apparatus of FIG. 3 according to an example.

FIG. 6 is a perspective view illustrating a portion of spraying units of the image forming apparatus of FIG. 3 according to an example.

FIG. 7 is a block diagram illustrating a maintenance device usable with an image forming apparatus according to an example.

FIG. 8 is a cross-sectional view illustrating the maintenance device of FIG. 7 according to an example.

FIG. 9 is a flowchart illustrating a method of maintaining a photoconductive member of an image forming apparatus according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Image forming apparatuses such as liquid electrophotography systems provide fluid such as liquid toner to a fluid applicator unit such as binary ink developers (BIDs). The liquid toner is charged and is provided to a latent image on a photoconductive member such as a photo imaging member (PIP) to form a fluid image, for example, by BIDs. The photoconductive member, in turn, provides the fluid image to an intermediate transfer member such as a heated intermediate transfer blanket. The heated intermediate transfer blanket transfers the fluid image onto a media and also transfer heat to the photoconductive member. The increased temperature of the photoconductive member may adversely impact the lifespan of the photoconductive member and the charging thereof. Contaminants and/or fluid residue may undesirably remain on the photoconductive member and negatively contribute to printing side effects and reduce the lifespan of the photoconductive member.

In examples, an image forming apparatus includes, among other things, sponge applicator units configured to cool and clean a photoconductive member such that each one of the sponge applicator units sequentially contacts the photoconductive member. Each one of the sponge applicator units sequentially contacts the photoconductive member after the fluid such as liquid toner applied to the photoconductive member is transferred therefrom, for example, in the form of the fluid image. That is, the sequential contact between the respective sponge applicator units and the photoconductive member occurs after the photoconductive member transfers the fluid image to an intermediate transfer member and/or the intermediate transfer member transfers the fluid image onto the media.

In examples, the image forming apparatus also includes spraying units disposed across from the sponge applicator units to provide fields of spray of sponge applicator fluid onto the sponge applicator units. The sponge applicator fluid is applied prior to the contact between the respective sponge applicator unit and the photoconductive member. The sponge applicator units are cooled by the sponge applicator fluid received thereon. The image forming apparatus also includes a squeeze unit configured to squeeze the sponge applicator units prior to the contact between the respective sponge applicator units and the photoconductive member. Thus, the potential for an excessive amount of sponge applicator fluid to be transferred from the squeeze unit to the photoconductive member is reduced. Such sequential contacts by each one of the sponge applicator units with the photoconductive member reduce the potential of printing defects, improper charging, and shortening the lifespan of the photoconductive member.

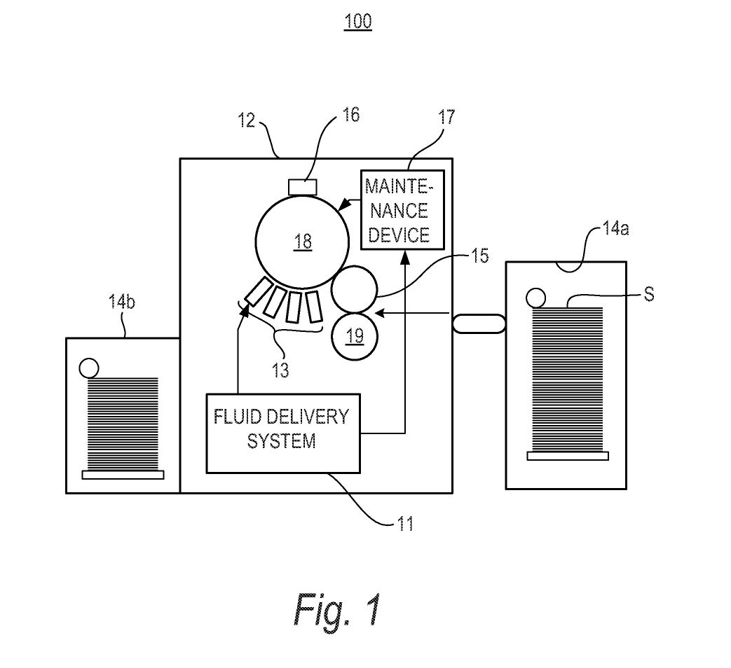

FIG. 1 is a schematic view illustrating an image forming apparatus such as a liquid electrophotography system (LEP) according to an example. Referring to FIG. 1, a LEP 100 includes an image forming unit 12 that receives a media S from an input unit 14a and outputs the substrate S to an output unit 14b. The image forming unit 12 includes a fluid applicator unit 13 and a photoconductive member 18 on which images can be formed. The photoconductive member 18 may be charged with a suitable charger (not illustrated) such as a charge roller. Portions of the outer surface of the photoconductive member 18 that correspond to features of the image can be selectively discharged by a laser writing unit 16 to form an electrostatic and/or latent image thereon.

Referring to FIG. 1, the LEP 100 also includes a fluid delivery system 11 to supply fluid including ink such as liquid toner, for example, ElectroInk, trademarked by Hewlett-Packard Company, to a fluid applicator unit 13 such as BIDs. In an example, the fluid delivery system 11 may also supply maintenance fluid (e.g., sponge applicator fluid) such as imaging oil to a maintenance device 17 The maintenance device 17 uses the maintenance fluid to maintain the photoconductive member 18 such as cooling and cleaning the photoconductive member 18. The fluid applicator unit 13 applies the fluid such as liquid toner to the electrostatic and/or latent image to form a fluid image on the photoconductive member 18 to be transferred to an intermediate transfer member (ITM) 15. The ITM 15 is configured to receive the fluid image from the photoconductive member 18, heat the fluid image, and transfer the fluid image to the media S. Heat from the ITM 15 may also transfer to the photoconductive member 18. During the transfer of the fluid image from the ITM 15 to the media S, the media S is pinched between the ITM 15 and an impression member 19. Once the fluid image has been transferred to the media S, the media S can be transported to the output unit 14b.

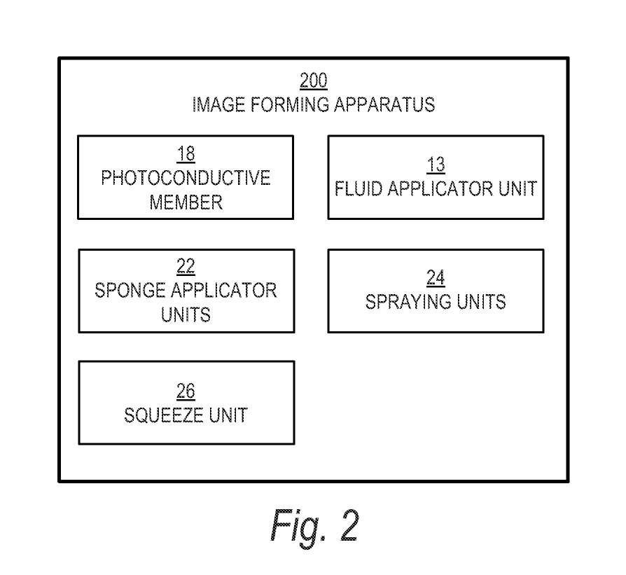

FIG. 2 is a block diagram illustrating an image forming apparatus according to an example. The image forming apparatus 200 may be a LEP 100. Referring to FIG. 2, in the present example, the image forming apparatus 200 includes a photoconductive member 18, a fluid applicator unit 13, a plurality of sponge applicator units 22, a plurality of spraying units 24, and a squeeze unit 26. The photoconductive member 18 is configured to receive fluid thereon and transfer the fluid in a form of a fluid image therefrom. In an example, the photoconductive member 18 may include a photo imaging plate configured to form a latent image thereon. The fluid applicator unit 13 is configured to apply the fluid including ink such as liquid toner to the photoconductive member 18 to form the fluid image thereon. In an example, the fluid applicator unit 13 may include one BID. In other examples, the fluid applicator unit 13 may include a plurality of BIDs. For example, each BID may correspond to a respective color fluid such as black ink, cyan ink, yellow ink, and magenta ink.

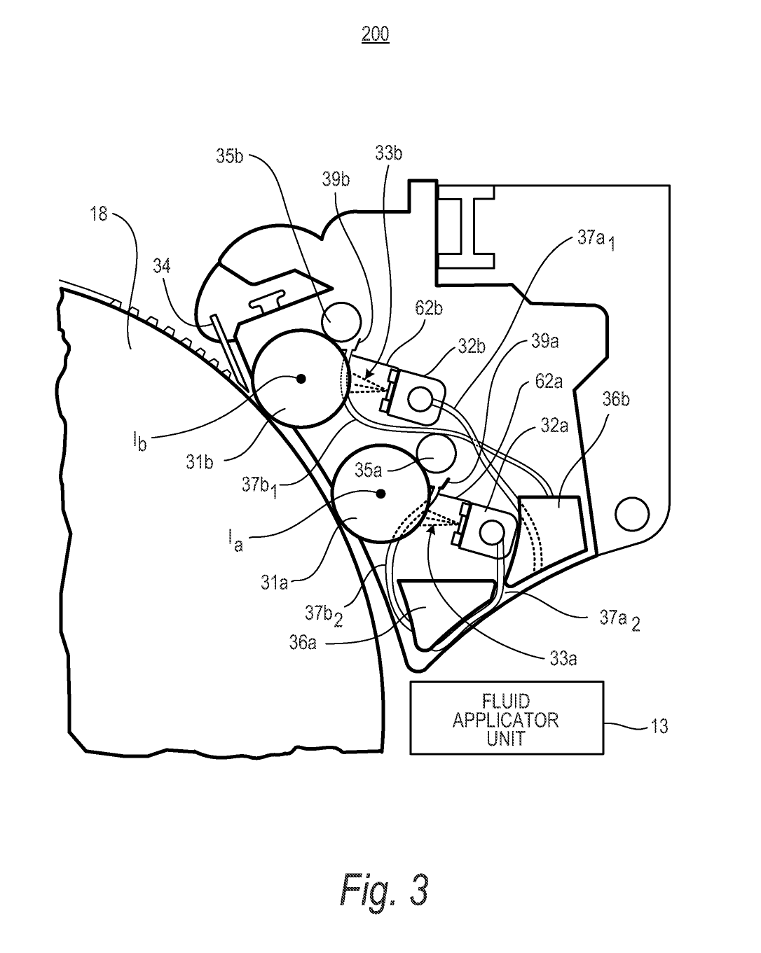

Referring to FIG. 2, the sponge applicator units 22 are configured to cool and clean the photoconductive member 18. Each one of the sponge applicator units 22 sequentially contacts the photoconductive member 18 after the fluid such as liquid toner is applied to the photoconductive member 18 is transferred therefrom, for example, in the form of the fluid image. That is, the sequential contact between the respective sponge applicator units 22 and the photoconductive member 18 occurs after the photoconductive member 18 transfers the fluid image to an intermediate transfer member 15 and/or the intermediate transfer member 15 transfers the fluid image onto the media. The spraying units 24 are disposed across from the sponge applicator units 22 (FIG. 3). The spraying units 24 are configured to provide fields of spray 33a and 33b (FIG. 3) of sponge applicator fluid onto the sponge applicator units 22. The sponge applicator fluid is provided to the respective sponge applicator units 22 prior to the sequential contact between the respective sponge applicator units 22 and the photoconductive member 18. The sponge applicator fluid may cool the sponge applicator units 22. Subsequently, the sponge applicator units 22 cooled by the sponge applicator fluid are placed in sequential contact with and, among other things, cool and clean the photoconductive member 18. Thus, fluid residuals remaining on the photoconductive member 18 after the transfer of the fluid image therefrom may be removed.

Referring to FIG. 2, the squeeze unit 26 is configured to squeeze the sponge applicator units 22. That is, the squeeze unit 26 contacts and applies pressure to the sponge applicator units 22 to remove at least a portion of the sponge applicator fluid thereon. Each one of the respective sponge applicator units 22 are squeezed prior to its respective sequential contact with the photoconductive member 18. Thus, an amount of sponge applicator fluid which ultimately is transferred from the sponge applicator units 22 to the photoconductive member 18 is reduced. Accordingly, the potential for the photoconductive member 18 to receive an excessive amount of sponge applicator fluid from the sponge applicator units 22 and inadvertently drip the sponge applicator fluid therefrom is reduced.

FIG. 3 is a cross-sectional view illustrating a portion of the image forming apparatus of FIG. 2 according to an example. Referring to FIGS. 2 and 3, in examples, the image forming apparatus 200 may also include a plurality of fluid storing chambers 36a and 36b, a plurality of fluid receiving paths 37a₁ and 37b₁, one or more supply paths 37a₂ and 37b₂, and a wiping unit 34. The fluid storing chambers 36a and 36b are configured to receive the sponge applicator fluid removed from the respective sponge applicator units 22. In the present example, the fluid receiving paths 37a₁ and 37b₁ are configured to transport the respective sponge applicator fluid between the sponge applicator units 22 and the fluid storing chambers 36a and 36b, respectively. Each one of the fluid storing chambers 36a and 36b correspond to a respective sponge applicator unit 22. In an example, the respective fluid storing chambers 36a and 36b may also facilitate transportation of the sponge applicator fluid between the sponge applicator units 22 and the spraying units 24. Consequently, fog and mist formed by the sponge applicator fluid escaping to outside of the image forming apparatus 200 may be reduced.

In an example, each one of the respective fluid receiving paths 37a₁ and 37b₁ may include a catch basin 39a and 39b to catch the sponge applicator fluid squeezed from the respective sponge rollers 31a and 31b. In other examples, the catch basins 39a and 39b and fluid receiving paths 37a₁ and 37b₁ may be in a form of shielding members 62a and 62b disposed between the respective sponge rollers 31a and 31b and the respective fluid storing chambers 36a and 36b to direct the squeezed sponge applicator fluid from the respective sponge rollers 36a and 36b to the respective fluid storing chambers 36a and 36b. The fluid supply paths 37a₂ and 37b₂ may be configured to supply sponge applicator fluid to the spraying units 32a and 32b, respectively. In an example, the fluid supply paths 37a₂ and 37b₂ may be disposed between the spraying units 32a and 32b and the fluid storing chambers 36a and 36b, respectively. In an example, the fluid storing chambers 36a and 36b may filter the received sponge applicator fluid and provide the filtered sponge applicator fluid back to the respective spraying units 32a and 32b.

Alternatively, one fluid supply path may supply the sponge applicator fluid to the spraying units 22. For example, the spraying units 32a and 32b may be integrally formed having a common supply inlet and/or in fluid communication with each other. The one supply path may directly or indirectly supply the sponge applicator fluid from the fluid storing chambers 36a and 36b. For example, a fluid tank (not illustrated) of the fluid delivery system 11 (FIG. 1) may receive the sponge applicator fluid from the fluid storing chambers 36a and 36b and provide it to spraying units 22 through the one supply path. Accordingly, one fluid supply path may transport the sponge applicator fluid from the respective fluid storing chambers 36a and 36b to the common supply inlet for both spraying units 32a and 32b.

Referring to FIGS. 2 and 3, the wiping unit 34 is configured to level the sponge application fluid on the photoconductive member 18 to form an even fluid thickness thereof. For example, sponge applicator fluid on the photoconductive member 18 is wiped by the wiping unit 34 after the sequential contact between the sponge applicator units 22 and the photoconductive member 18. The photoconductive member 18 may be wiped before it is recharged for a new image forming cycle. The wiper unit 34 may include a blade such as a licking deformable blade. In the present example, the licking deformable blade may be spaced apart from the photoconductor member 18 and configured to remove access sponge applicator fluid from the photoconductive member 18 to maintain an even fluid thickness thereof. The photoconductive member 18 having the sponge applicator fluid thereon with the even fluid thickness may then be charged. The licking deformable blade may maintain the even fluid thickness while allowing fluid particles to pass thereby. The sponge applicator fluid may include imaging oil such as Isopar trademarked by Exxon Corporation.

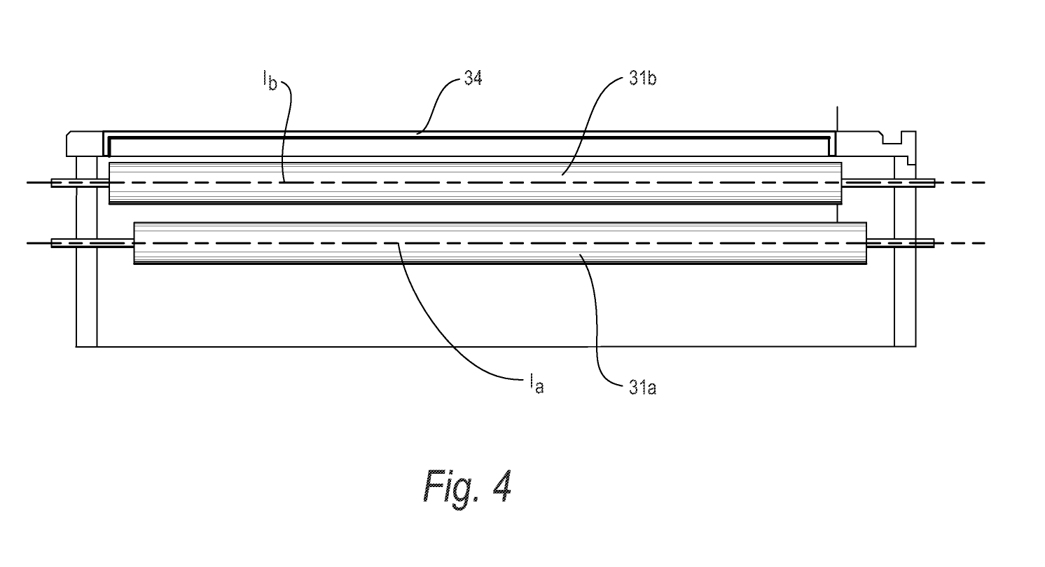

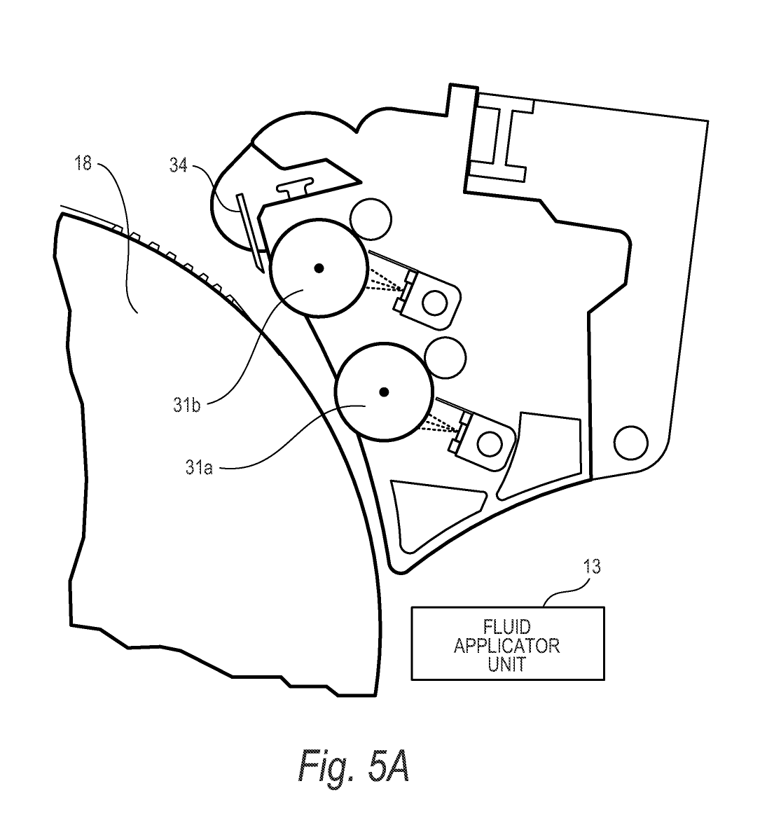

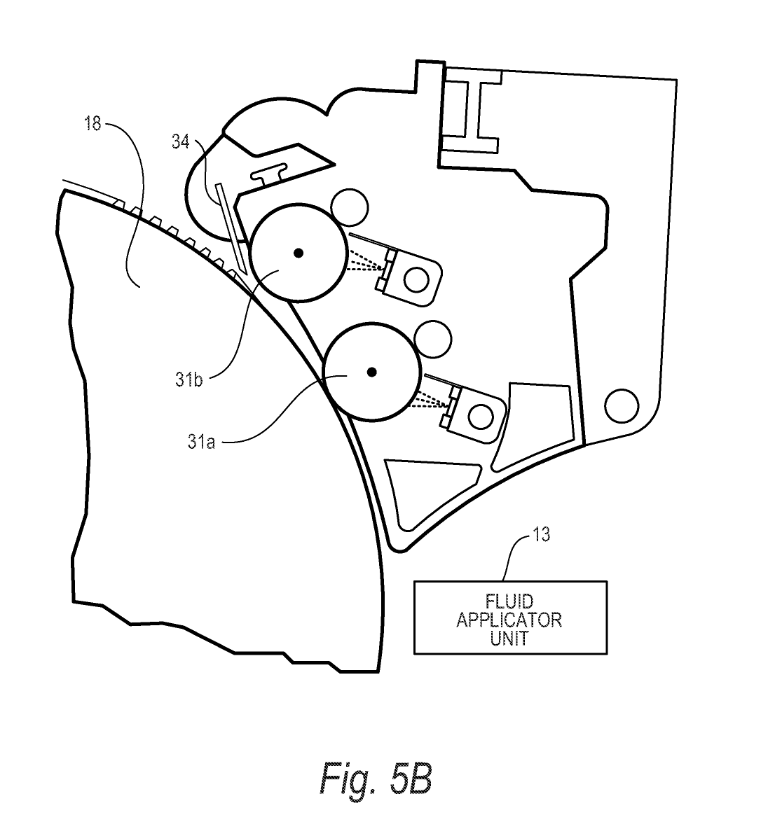

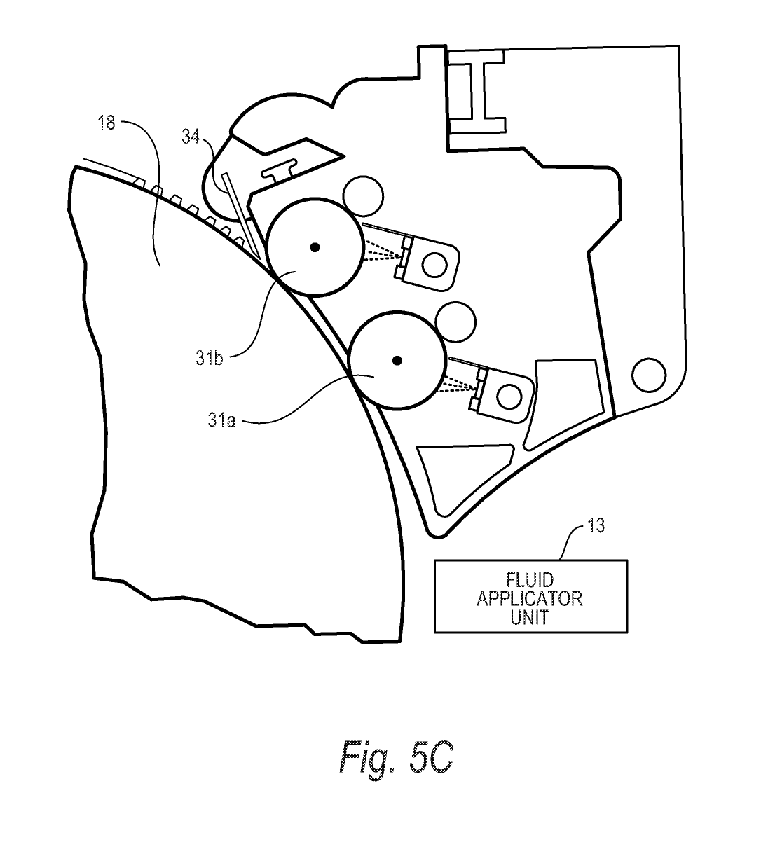

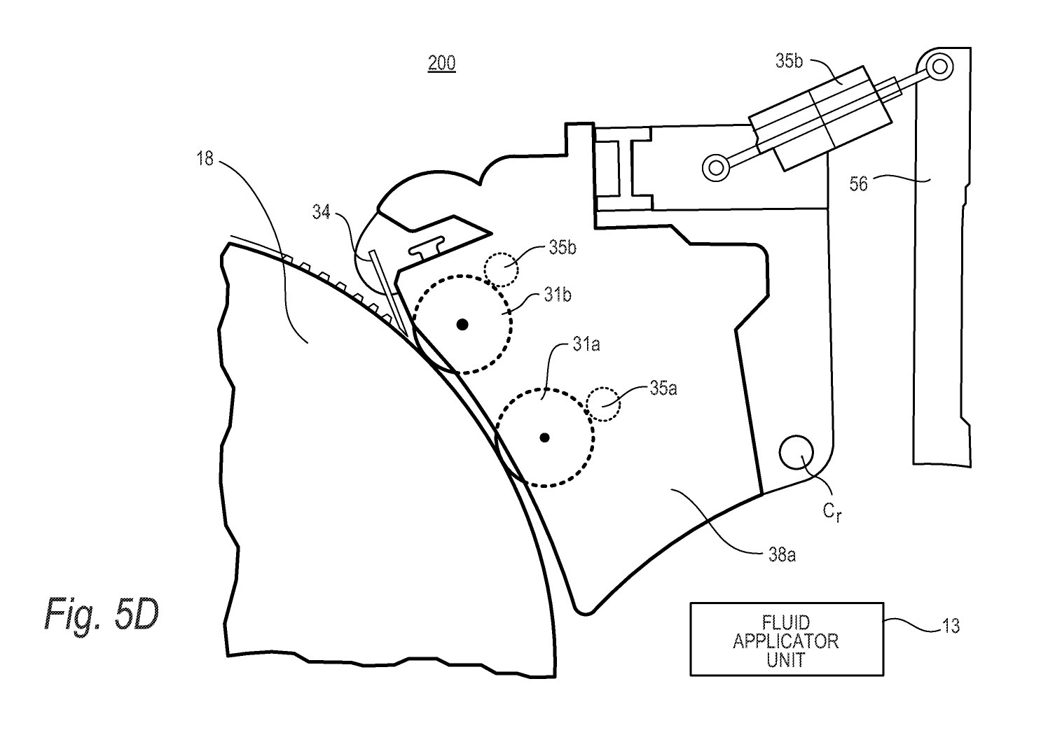

Referring to FIGS. 2 and 3, in an example, the sponge applicator units 22 may include a first sponge roller 31a movable between a sponge contact state and a sponge non-contact state with the photoconductive member 18. The sponge contact state is a state in which a respective sponge roller 31a and 31b is in contact with the photoconductive member 18. The sponge non-contact state is a state in which the respective sponge roller 31a and 31b is not in contact with the photoconductive member 18. In an example, each one of the first sponge roller 31a and the second sponge roller 31b may form respective nip lengths with the photoconductive member 18. The respective nip lengths may be predetermined and correspond to an amount of cooling to be applied to the photoconductive member 18. In the present example, the first sponge roller 31a is configured to rotate about a first longitudinal axis I, (FIG. 4) therein to cool and clean the photoconductive member 18 when placed in the sponge contact state therewith as illustrated in FIG. 5B. For example, the contact between the photoconductive member 18 and the first sponge roller 31a previously cooled with sponge applicator fluid cools the photoconductive member 18. Additionally, the force of the first sponge roller 31a in contact with and rotating against the photoconductive member 18 cleans the photoconductive member 18 by forcing fluid residue, or the like, therefrom.

In the present example, the second sponge roller 31b is movable between the sponge contact state and the sponge non-contact state with respect to the photoconductive member 18. The second sponge roller 31b is configured to rotate about a second longitudinal axis l_{b} (FIG. 4) therein to cool and clean the photoconductive member 18 when placed in the sponge contact state therewith as illustrated in FIG. 5C. For example, the contact between the photoconductive member 18 and the second sponge roller 31b previously cooled with sponge applicator fluid further cools and cleans the photoconductive member 18. Additionally, the force of the second sponge roller 31b in contact with and rotating against the photoconductive member 18 cleans the photoconductive member 18 by forcing fluid residue, or the like, therefrom. In the present example, the sequential contact of the sponge applicator units 22 and the photoconductor member 18 include a first sponge roller 31a initially being placed in a sponge contact state while the second sponge roller 31b is in (e.g., remains in) the sponge non-contact state. Subsequently, the second sponge roller 31b may be placed in the sponge contact state while the first sponge roller 31a is in (e.g., remains in) the sponge contact state. Alternatively, in the subsequent stage, the second sponge roller 31b may be placed in the sponge contact state while the first sponge roller 31a is in the sponge non-contact state.

In other examples, the sequential contact of the sponge applicator units 22 and the photoconductor member 18 may include the second sponge roller 31b initially being placed in the sponge contact state while the first sponge roller 31a is in the sponge non-contact state. Subsequently, the first sponge roller 31a may be placed in the sponge contact state while the second sponge roller 31b is in (e.g., remains in) the sponge contact state.

Referring to FIGS. 2 and 3, the squeeze unit 26 may include a first squeegee roller 35a and a second squeegee roller 35b. The first squeegee roller 35a is configured to squeeze the first sponge roller 31a to remove at least a portion of the sponge applicator fluid provided thereto by the first set of spraying units 32a. The second squeegee roller 35b is configured to squeeze the second sponge roller 31b to remove at least a portion of the sponge applicator fluid provided thereto by the second set of spraying units 32b. In the present example, the first squeegee roller 35a and the second squeegee roller 35b are in constant contact with the first sponge roller 31a and the second sponge roller 31b, respectively.

In other examples, the first squeegee roller 35a and the second squeegee roller 35b may be in movable contact with the respective sponge rollers 31a and 31b. That is, each one of the squeegee rollers 35a and 35b may selectively move in and out of contact with the respective sponge rollers 31a and 31b. For example, the first squeegee roller 35a may move into contact with the first sponge roller 31a after sponge application fluid is applied thereto and before the first sponge roller 31a contacts the photoconductive member 18. The second squeegee roller 35b may move into contact with the second sponge roller 31b after sponge application fluid is applied thereto and before the second sponge roller 31b contacts the photoconductive member 18.

FIG. 4 is an elevational view illustrating sponge rollers and the wiping unit of the image forming apparatus of FIG. 3 according to an example. Referring to FIG. 4, in an example, a first sponge roller 31a has a first longitudinal axis lₐ therein and is configured to rotate thereabout. The second sponge roller 31b has a second longitudinal axis l_{b} therein and is configured to rotate thereabout. In the present example, the wiper unit 34 is parallel to and extends along a longitudinal axis (not illustrated) of the photoconductive member 18. The wiping unit 34 and/or blade thereof may extend across approximately the entire length of the photoconductive member 18. In examples, the wiper unit 34 is disposed across from and extends parallel to at least one of the longitudinal axis lₐ and l_{b} of the respective sponge rollers 31a and 31b.

FIGS. 5A-5C are schematic diagrams of sequential engagement states of the respective sponge rollers of the image forming apparatus of FIG. 3 according to an example. Referring to FIG. 5A, the respective sponge rollers 31a and 31b are in a disengagement state. That is, both the first sponge roller 31a and the second sponge roller 31b are in a sponge non-contact state with respect to the photoconductive member 18. Referring to FIG. 5B, the respective sponge rollers 31a and 31b are in a semi-engagement state. That is, the first sponge roller 31a is in a sponge contact state and the second sponge roller 31b is in a sponge non-contact state with respect to the photoconductive member 18. Alternatively, the semi-engagement state may include the first sponge roller 31a being in a sponge non-contact state and the second sponge roller 31b being in a sponge contact state with respect to the photoconductive member 18. Referring to FIG. 5C, the respective sponge rollers 31a and 31b are in a full engagement state. That is, both the first sponge roller 31a and the second sponge roller 31b are in a sponge contact state with respect to the photoconductive member 18.

FIG. 5D is a side view including a maintenance assembly frame of the image forming apparatus of FIG. 3 according to an example. Referring to FIG. 5D, in an example, the respective sponge rollers 31a and 31b may be rotatably connected to a maintenance assembly frame 38a. The maintenance assembly frame 38a may be movable with respect to the photoconductive member 18 to place the first sponge roller 31a and the second sponge roller 31b in the various sequential engagement states as illustrated in FIGS. 5A, 5B and 5C. The maintenance assembly frame 38a may be removably installed in the image forming apparatus 200 and engage with a rotary engagement system 55 to move at least a portion of the maintenance assembly frame 38a toward and away from the photoconductive member 18. In an example, the maintenance assembly frame 38a may pivot about a rotational center cᵣ thereof. In the present example, the distances between the rotational center cᵣ of the maintenance assembly frame 38a and longitudinal axis lₐ and l_{b} of the respective sponge rollers 31a and 31b are different to enable the various sequential engagement states between the respective sponge 31a and 31b and the photoconductive member 18.

Referring to FIG. 5D, the rotary engagement system 55 may include double pneumatic cylinders having multiple stages, for example, to correspond with the respective engagement states of the sponge rollers 31a and 31b. One cylinder of the rotary engagement system 55 may be connected to a main frame 56 of the image forming apparatus 200 and the other cylinder may engage directly or indirectly with the movable maintenance assembly frame 38a. The rotary engagement system 55 may selectively place the maintenance assembly frame 38a into the disengagement state (FIG. 5A), semi-engagement state (FIG. 5B), and full engagement state (FIG. 5C). In examples, the respective sponge rollers 31a and 31b, squeegee rollers 35a and 35b, spraying units 32a and 32b, fluid storage chambers 36a and 36b, fluid receiving paths 37a₁ and 37b₁, and fluid supply paths 37a₂ and 37b₂ may be connected to and/or contained within the maintenance assembly frame 38a.

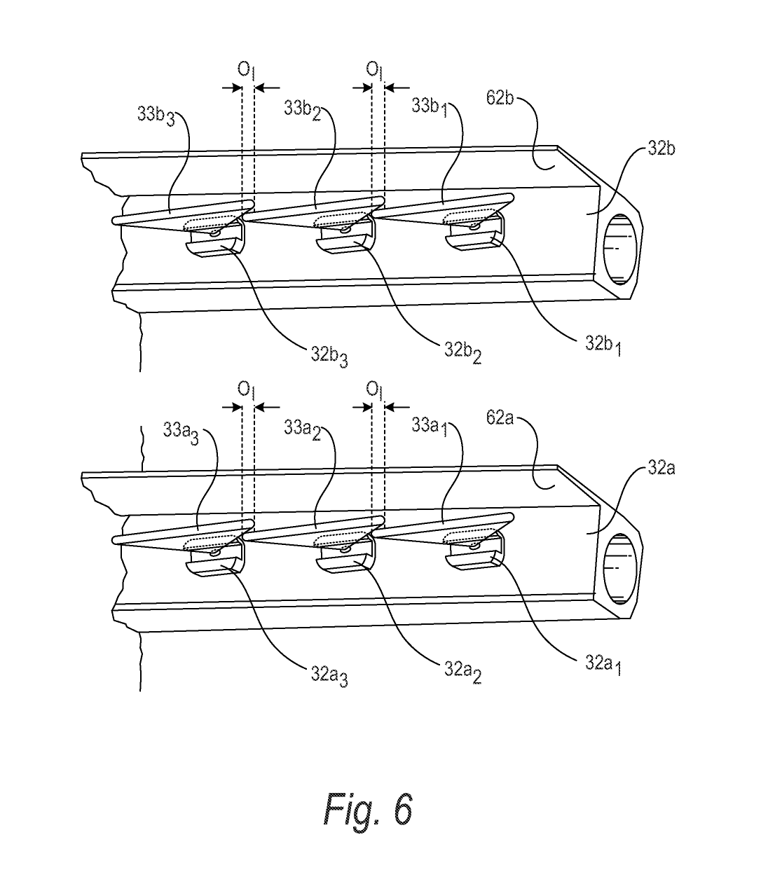

FIG. 6 is a perspective view illustrating a portion of spraying units of the image forming apparatus of FIG. 3 according to an example. Referring to FIGS. 3, 4 and 6, in an example, the spraying units 22 include a first set of spraying units 32a and a second set of spraying units 32b. The first set of spraying units 32a may be arranged across from and parallel to the first longitudinal axis I, of the first sponge roller 31a. The first set of spraying units 32a is configured to provide fields of spray 33a of sponge applicator fluid onto the first sponge roller 31a such that portions of respective fields of spray 33a₁, 33a₂ and 33a₃ of adjacent spraying units 32a₁, 32a₂ and 32a₃ form overlap regions oₗ with each other. The second set of spraying units 32b is arranged across from and parallel to the second longitudinal axis l_{b} of the second sponge roller 31b. The second set of spraying units 32b is configured to provide fields of spray 33b of sponge applicator fluid onto the second sponge roller 31b such that portions of respective fields of spray 33b₁, 33b₂, and 33b₃ of adjacent spraying units form overlap regions oₗ with each other.

Referring to FIGS. 3, 4 and 6, in an example, the first set of spraying units 32a and the second set of spraying units 32b may include respective shielding members 62a and 62b. The respective shielding members 62a and 62b are configured to shield each one of the sponge rollers 35a and 35b from passing contaminants, or the like, from one sponge roller to the other sponge roller. In an example, the shielding members 62a and 62b may also form a shielding area proximate to an area in which the respective sponge rollers 31a and 31b and the respective squeegee rollers 35a and 35b contact each other to reduce an amount of fog and mist from escaping therefrom. In yet another example, the shielding members 62a and 62b may be elongated and extend from proximate to the respective sponge rollers 31a and 31b to the respective fluid storing chambers 36a and 36b. In this capacity, the shielding members 62a and 62b may replace the fluid receiving members 37a₁ and 37b₁ to direct the squeezed sponge applicator fluid from the respective sponge rollers 31a and 31b to the respective fluid storing chambers 36a and 36b.

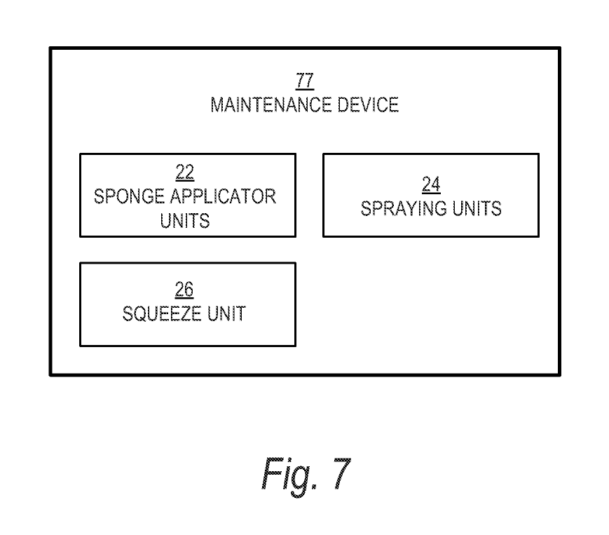

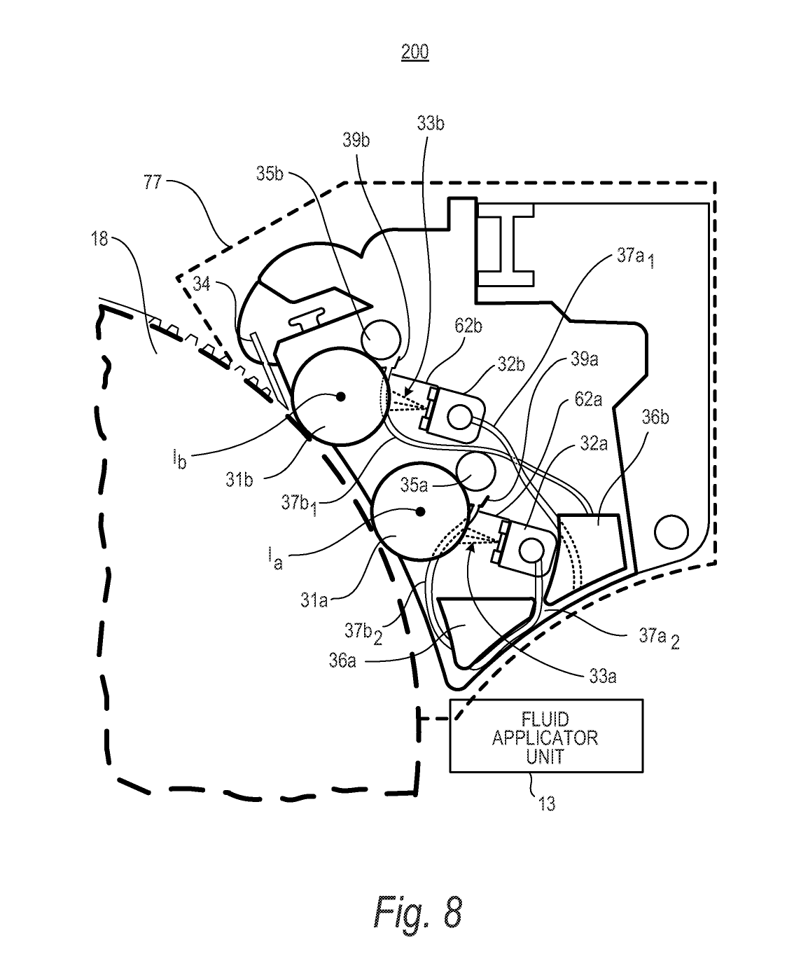

FIG. 7 is a block diagram illustrating a maintenance device and a wiping unit according to an example. FIG. 8 is a cross-sectional view illustrating a maintenance device according to an example. The maintenance device 77 is usable with an image forming apparatus 200 (FIG. 2). The image forming apparatus 200 includes a photoconductive member 18 to receive fluid thereon and transfer the fluid therefrom in a form of an image. The image forming apparatus 200 also includes a fluid applicator unit 13 to apply the fluid including ink such as liquid toner to the photoconductive member 18. Referring to FIGS. 7 and 8, in the present example, the maintenance device 77 includes a plurality of sponge applicator units 22, a plurality of spraying units 24, and a squeeze unit 26. The sponge applicator units 22 are configured to clean and cool the photoconductive member 18 such that each one of the sponge applicator units 22 sequentially contacts the photoconductive member 18 after the fluid applied to the photoconductive member 18 is transferred therefrom. For example, the sequential contact between the respective sponge applicator units 22 and the photoconductive member 18 occurs after the photoconductive member 18 transfers the fluid image to an intermediate transfer member 15 and/or the intermediate transfer member 15 transfers the fluid image onto the media.

Referring to FIG. 7, the spraying units 24 are disposed across from the sponge applicator units 22. The spraying units 24 are configured to provide fields of spray 33a and 33b of sponge applicator fluid onto the sponge applicator units 22 prior to the sequential contact between the sponge applicator units 22 and the photoconductive member 18. The squeeze unit 26 is configured to squeeze the sponge applicator units 22. The sponge applicator units 22 are squeezed prior to the sequential contact between the sponge applicator units 22 and the photoconductive member 18.

Referring to FIG. 8, the maintenance device 77 may also include a plurality of fluid storing chambers 36a and 36b, a plurality of fluid receiving paths 37a₁ and 37b₁, one or more fluid supply paths 37a₂ and 37b₂, a wiping unit 34, and a maintenance assembly frame 38a as previously disclosed with respect to the image forming apparatus of FIG. 3. In examples, the sponge applicator units 22 may include a first sponge roller 31a and a second sponge roller 31b, the spraying units 24 may include a first set of spraying units 32a and a second set of spraying units 32b, the squeeze unit 26 may include a first squeegee roller 35a and a second squeegee roller 35b, and sets of the spraying units 32a and 32b may include shielding members 62a and 62b as previously disclosed with respect to the image forming apparatus 200 of FIG. 3.

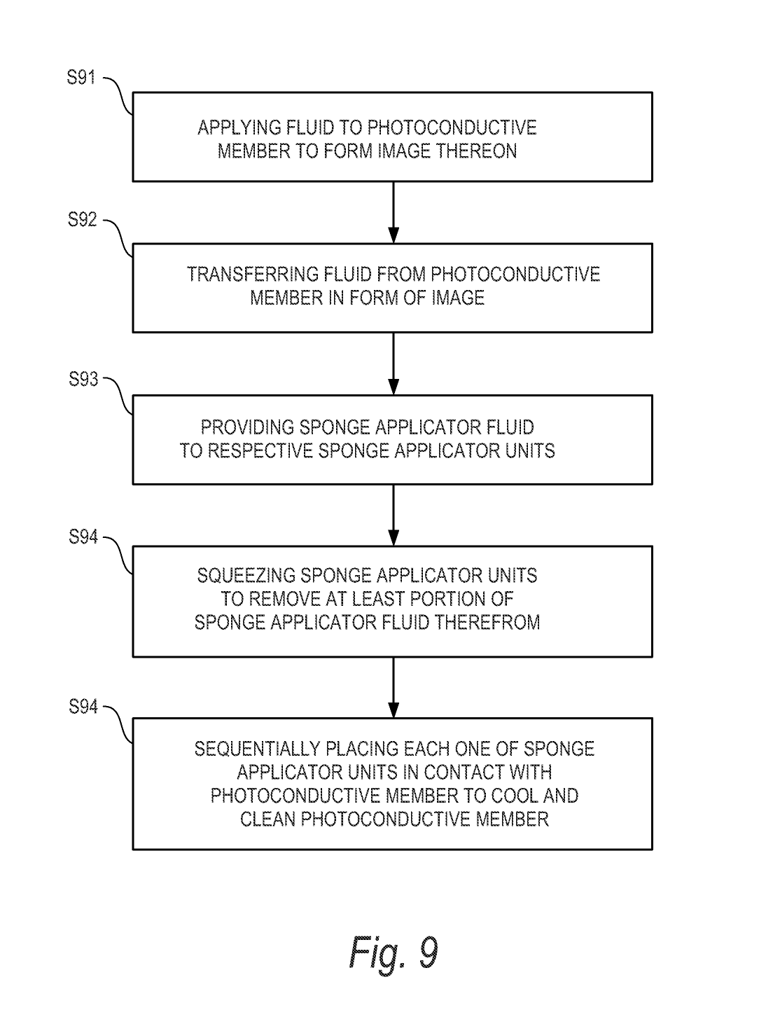

FIG. 9 is a flowchart illustrating a method of maintaining a photoconductive member of an image forming apparatus according to an example. Referring to FIG. 9, in block S91, fluid is applied to a photoconductive member to form an image thereon. In block S92, the fluid is transferred from the photoconductive member in the form of the image. In block S93, sponge applicator fluid is provided to respective sponge applicator units. In an example, the sponge applicator fluid includes imaging oil. In an example, providing the sponge applicator fluid to respective sponge applicator units may include providing fields of spray of the sponge applicator fluid onto the sponge applicator units by each one of a plurality of spraying units disposed across from the sponge applicator units.

In an example, the respective sponge applicator units may include a first sponge roller and a second sponge roller. The first sponge roller may be movable between a sponge contact state and a sponge non-contact state with the photoconductive member. The first sponge roller may be configured to rotate about a first longitudinal axis therein to cool and clean the photoconductive member when placed in the sponge contact state therewith. The second sponge roller may be movable between the sponge contact state and the sponge non-contact state with the photoconductive member. The second sponge roller may be configured to rotate about a second longitudinal axis therein to cool and clean the photoconductive member when placed in the sponge contact state therewith.

In an example, providing the sponge applicator fluid to respective sponge applicator units includes providing fields of spray of the sponge applicator fluid onto the first sponge roller by a first set of spraying units arranged in a longitudinal direction across from the first sponge roller. Portions of respective fields of spray of adjacent spraying units of the first set of spraying units 32 form overlap regions with each other. Providing the sponge applicator fluid to respective sponge applicator units may also include providing fields of spray of the sponge applicator fluid onto the second sponge roller by a second set of spraying units arranged in a longitudinal direction across from the second sponge roller. Portions of respective fields of spray of adjacent spraying units of the second set of spraying units 32b form overlap regions with each other.

In block S94, the sponge applicator units are squeezed to remove at least a portion of the sponge applicator fluid therefrom. In block S95, each one of the sponge applicator units is sequentially placed in contact with the photoconductive member to cool and clean the photoconductive member. In examples, the method may further include wiping the sponge applicator fluid on the photoconductive member to level the sponge application fluid thereon to form an even fluid thickness thereof after sequentially placing each one of the sponge applicator units in contact with the photoconductive member. The method may also include transporting the at least a portion of the sponge applicator fluid removed from each one of the sponge applicator units to a respective one of a plurality of fluid storing chambers.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A method of maintaining a photoconductive member of an image forming apparatus, the method comprising:
applying fluid to a photoconductive member to form an image thereon;
transferring the fluid from the photoconductive member in the form of the image;
providing sponge applicator fluid to respective sponge applicator units;
squeezing the sponge applicator units to remove at least a portion of the sponge applicator fluid therefrom; and
sequentially placing each one of the sponge applicator units in contact with the photoconductive member to cool and clean the photoconductive member.

2. The method according to claim 1, further comprising:
removing from the photoconductive member at least a portion of the sponge applicator fluid after sequentially placing each one of the sponge applicator units in contact with the photoconductive member; and
transporting the at least a portion of the sponge applicator fluid removed from each one of the sponge applicator units to a respective one of a plurality of fluid storing chambers.

3. The method according to claim 1, wherein the providing the sponge applicator fluid to respective sponge applicator units comprises:
providing fields of spray of the sponge applicator fluid onto the sponge applicator units by each one of a plurality of spraying units disposed across from the sponge applicator units.

4. The method according to claim 1, wherein the respective sponge applicator units comprise:
a first sponge roller movable between a sponge contact state and a sponge non-contact state with the photoconductive member, the first sponge roller configured to rotate about a first longitudinal axis therein to cool and clean the photoconductive member when placed in the sponge contact state therewith; and
a second sponge roller movable between the sponge contact state and the sponge non-contact state with the photoconductive member, the second sponge roller configured to rotate about a second longitudinal axis therein to cool and clean the photoconductive member when placed in the sponge contact state therewith.

5. The method according to claim 4, wherein the providing the sponge applicator fluid to respective sponge applicator units comprises:
providing fields of spray of the sponge applicator fluid onto the first sponge roller by a first set of spraying units arranged across from the first sponge roller such that portions of respective fields of spray of adjacent spraying units form overlap regions with each other; and
providing fields of spray of the sponge applicator fluid onto the second sponge roller by a second set of spraying units arranged across from the second sponge roller such that portions of respective fields of spray of adjacent spraying units form overlap regions with each other.

6. The method according to claim 1, wherein the sponge applicator fluid comprises imaging oil and the image forming apparatus comprises a liquid electrophotography system.

7. A maintenance device usable with an image forming apparatus having a photoconductive member to receive and transfer fluid therefrom in a form of an image and a fluid applicator unit to apply the fluid to the photoconductive member, the maintenance device comprising:
a plurality of sponge applicator units configured to clean and cool the photoconductive member such that each one of the sponge applicator units sequentially contacts the photoconductive member after the fluid applied to the photoconductive member is transferred therefrom;
a plurality of spraying units disposed across from the sponge applicator units, the spraying units configured to provide fields of spray of sponge applicator fluid onto the sponge applicator units prior to the sequential contact between the sponge applicator units and the photoconductive member; and
a squeeze unit configured to squeeze the sponge applicator units such that the sponge applicator units are squeezed prior to the sequential contact between the sponge applicator units and the photoconductive member.

8. The maintenance device according to claim 7, wherein sponge applicator units comprise:
a first sponge roller movable between a sponge contact state and a sponge non-contact state with the photoconductive member, the first sponge roller configured to rotate about a first longitudinal axis therein to cool and clean the photoconductive member when placed in the sponge contact state therewith; and
a second sponge roller movable between the sponge contact state and the sponge non-contact state with the photoconductive member, the second sponge roller configured to rotate about a second longitudinal axis therein to cool and clean the photoconductive member when placed in the sponge contact state therewith.

9. The maintenance device according to claim 8, wherein the spraying units comprise:
a first set of spraying units arranged across from the first sponge roller, the first set of spraying units configured to provide fields of spray of sponge applicator fluid onto the first sponge roller such that portions of respective fields of spray of adjacent spraying units form overlap regions with each other; and
a second set of spraying units arranged across from the second sponge roller, the second set of spraying units configured to provide fields of spray of sponge applicator fluid onto the second sponge roller such that portions of respective fields of spray of adjacent spraying units form overlap regions with each other.

10. The maintenance device according to claim 9, wherein the squeeze unit comprises:
a first squeegee roller configured to squeeze the first sponge roller to remove at least a portion of the sponge applicator fluid provided thereto by the first set of spraying units; and
a second squeegee roller configured to squeeze the second sponge roller to remove at least a portion of the sponge applicator fluid provided thereto by the second set of spraying units.

11. The maintenance device according to claim 7, further comprising:
a plurality of fluid storing chambers configured to receive the sponge applicator fluid from the sponge applicator units, respectively;
a plurality of fluid receiving paths configured to transport the respective sponge applicator fluid between the sponge applicator units and the fluid storing chambers, respectively; and
a wiping unit configured to level the sponge application fluid on the photoconductive member to form an even fluid thickness thereof after the sequential contact between the sponge applicator units and the photoconductive member.

12. The maintenance device according to claim 11, wherein the wiper unit comprises:
a licking deformable blade configured to remove access sponge applicator fluid from the photoconductive member to maintain an even fluid thickness thereof while allowing fluid particles to pass thereby.

13. The maintenance device according to claim 7, wherein the sponge applicator fluid comprises:
imaging oil.

14. An image forming apparatus, comprising:
a photoconductive member configured to receive fluid thereon and transfer the fluid in a form of an image therefrom;
a fluid applicator unit configured to apply the fluid to the photoconductive member to form the image thereon;
a plurality of sponge applicator units configured to cool and clean the photoconductive member such that each one of the sponge applicator units sequentially contacts the photoconductive member after the fluid applied to the photoconductive member is transferred therefrom;
a plurality of spraying units disposed across from the sponge applicator units, the spraying units configured to provide fields of spray of sponge applicator fluid onto the sponge applicator units prior to the sequential contact between the sponge applicator units and the photoconductive member; and
a squeeze unit configured to squeeze the sponge applicator units such that the sponge applicator units are squeezed prior to the sequential contact between the sponge applicator units and the photoconductive member.

15. The image forming system according to claim 14, wherein sponge applicator units comprise:
a first sponge roller movable between a sponge contact state and a sponge non-contact state with the photoconductive member, the first sponge roller configured to rotate about a first longitudinal axis therein to cool and clean the photoconductive member when placed in the sponge contact state therewith; and
a second sponge roller movable between the sponge contact state and the sponge non-contact state with the photoconductive member, the second sponge roller configured to rotate about a second longitudinal axis therein to cool and clean the photoconductive member when placed in the sponge contact state therewith.

16. The image forming apparatus according to claim 15, wherein the spraying units comprise:
a first set of spraying units arranged across from the first sponge roller, the first set of spraying units configured to provide fields of spray of sponge applicator fluid onto the first sponge roller such that portions of respective fields of spray of adjacent spraying units form overlap regions with each other; and
a second set of spraying units arranged across from the second sponge roller, the second set of spraying units configured to provide fields of spray of sponge applicator fluid onto the second sponge roller such that portions of respective fields of spray of adjacent spraying units form overlap regions with each other.

17. The image forming apparatus according to claim 16, wherein the squeeze unit comprises:
a first squeegee roller configured to squeeze the first sponge roller to remove at least a portion of the sponge applicator fluid provided thereto by the first set of spraying units; and
a second squeegee roller configured to squeeze the second sponge roller to remove at least a portion of the sponge applicator fluid provided thereto by the second set of spraying units.

18. The image forming apparatus according to claim 14, further comprising:
a plurality of fluid storing chambers configured to receive the respective sponge applicator fluid from the sponge applicator units, respectively;
a plurality of fluid receiving paths configured to transport the respective sponge applicator fluid between the sponge applicator units and the fluid storing chambers, respectively; and
a wiping unit configured to level the sponge application fluid on the photoconductive member to form an even fluid thickness thereof after the sequential contact between the sponge applicator units and the photoconductive member.

19. The image forming apparatus according to claim 18, wherein the wiper unit comprises:
a licking deformable blade configured to remove access sponge applicator fluid from the photoconductive member to maintain an even fluid thickness thereof while allowing fluid particles to pass thereby.

20. The image forming apparatus according to claim 14, wherein the sponge applicator fluid comprises imaging oil and the image forming apparatus comprises a liquid electrophotography system.
